(19) United States
(12) Patent Application Publication
(10) Pub. No.: US 2008/0211908 A1
(43) Pub. Date: Sep. 4, 2008

(54) Monitoring Method and Device

(75) Inventors: Ira Dvir, Rishon-Lezion (IL); Nitzan Rabinowitz, Ramat Hasharon (IL); Vladimir Gorstein, Kfar Saba (IL)

Correspondence Address: DEBORAH A. GADOR, P.O. BOX 4133, GANEL TIKVA, 55900, IL

(73) Assignee: HUMAN MONITORING LTD, GIVAT HASHLOSHA (IL)

(21) Appl. No.: 11/914,454

(22) PCT Filed: May 15, 2006
(86) PCT No.: PCT/IL2006/000572

§ 371 Date: Nov. 15, 2007

Related U.S. Application Data
(60) Provisional application No. 60/681,047, filed on May 16, 2005.

(51) Int. Cl. H04N 7/18

(52) U.S. Cl. 348/143; 348/E07.085

(57) ABSTRACT

A method for monitoring including capturing video frames over time, processing data from the captured video frames into derived data representing a rate of change of the captured data, creating new frames from the derived data, and storing and/or displaying the new frames.

### FIELD OF THE INVENTION

The present invention relates to monitoring devices, in general and, in particular, to monitoring devices which protect the privacy of those being monitored.

### BACKGROUND OF THE INVENTION

The advent of optical technologies for surveillance and safety purposes poses challenging and ethical dilemmas regarding privacy keeping and violation in order to secure and protect property and people in both public and private places.

Recent research studies indicate that in 2011 an average person will be photographed or recorded on video at least a few times per day.

An increasing proliferation of video cameras is being used in both public and private locations to capture intrusion, prevent crimes, and provide alerts about various hazards. In most of the cases, the identification of a specific human individual is totally unnecessary, and it is only the presence or absence of people, vehicles or other objects that is of interest. Thus, privacy violation is not essential. In such cases, the surveillance or safety camera (or system) can perform its task without the need to intrude on the privacy of the watched people and/or surroundings.

A typical case of such a conflict is presented by the need to watch elderly demented patients, alerting staff to their intention to descend from their beds. Such an alert is essential, since a fall of such a patient could result in severe injury. However, using the existing equipment, i.e. surveillance cameras, is unacceptable, since it violates the privacy of the patients. Such violation is prohibited by legislation in many civilized countries.

Examining closely this very typical example reveals that there is no actual need for such a violation. The privacy intrusion is not imperative if the aim is merely to alert a paramedic or a nurse, or any attending individual, to rush and assist the patient to descend from his or her bed. It is only the intention of the patient to descend from the bed that should be reported.

The existing art of motion detection is incapable of differentiating specific human gestures and postures to allow such a report, thus in principle the existing solutions transfer the full image.

The awareness to the individual's right to keep one's privacy is in the first stages of wide acceptance. Even when dealing with residential alert systems for elderly people who need to be attended, the focus is put on the efficiency of the systems, rather than on the privacy of the individuals. The most accepted way of keeping home security and safety without violating privacy involves using non-optical sensors. Such examples can be found in indoor residential alert systems based on volume detectors and other kinds of mechanical vibration sensors, like the one disclosed by Johnson; Mark A. in U.S. Pat. No. 5,879,309.

The awareness of the need to allow individuals to avoid being photographed against their will finds its presentation in another US patent of Aoki; Hisashi U.S. Pat. No. 6,853,750. This patent discloses means for allowing individuals to “erase” their pictures from unwanted photographs or video sequences, allowing the camera or the camcorder to take “censored” video only.

However the privacy keeping of individuals in public places, stores (including dressing rooms) is rather poor. Hospitals keep the privacy of their patients by simply avoiding the use of optical monitoring in most of the wards. Home security systems suffice with limited motion detection sensors or suggest the use of IR cameras, even though they violate the privacy of the individuals that these systems are meant to protect.

In addition, there are many situations in which monitoring an area over time to detect motion is desirable. For example, monitoring babies to prevent crib death, or monitoring the flight path of an aircraft to warn of approaching obstacles, or observing the stealthy approach of enemy soldiers or aircraft, or tracking the motion of far-away vehicles. At present, all these tasks are difficult to perform or require complex mechanisms for monitoring and providing a warning.

Accordingly, there is a long felt need for a monitoring system which does not invade the privacy of those being monitored, and it would be very desirable if such a system were capable of monitoring a variety of different types of movement and moving objects.

### SUMMARY OF THE INVENTION

The present invention relates to a monitoring device and method for monitoring an area without invading privacy by providing images representing motion of objects in the area while filtering out details and stationary objects.

There is provided according to the present invention a method for monitoring including capturing video frames over time, processing data, preferably luminance data, from the captured video frames into derived data representing a rate of change of the captured data, creating new frames from the derived data, and storing and/or displaying the new frames.

According to one embodiment of the invention, the derived data representing a rate of change of said captured data above a threshold value is displayed in contrast to a the derived data representing a rate of change below said threshold value.

According to another embodiment of the invention, the method further includes determining from the derived data a direction of the rate of change, i.e., increasing or decreasing, and displaying one direction in contrast to an opposite direction.

There is also provided, according to the invention, a monitoring device including an optical sensor for acquiring a sequence of video frames over time, a processor for processing data from the acquired video frames into derived data representing a rate of change of the acquired data and for creating new frames from the derived data.

According to a preferred embodiment, the processor is adapted and configured for calculating at least a second derivative of luminance of each pixel in said frames as sampled over time and assigning said derivative value to each pixel, so as to create new frames representing movement of objects in said frames.

### BRIEF DESCRIPTION OF THE DRAWINGS

The present invention will be further understood and appreciated from the following detailed description taken in conjunction with the drawings in which:

FIG. 1 is an image provided by a monitoring device constructed and operative in accordance with one embodiment of the present invention for display;

FIG. 2 is a binary bitmap image provided by a monitoring device according to one embodiment of the invention for display;

FIG. 3 is a block diagram illustration of a monitoring device constructed and operative in accordance with one embodiment of the invention; and

FIGS. 4a and 4b are images illustrating directionality of motion.

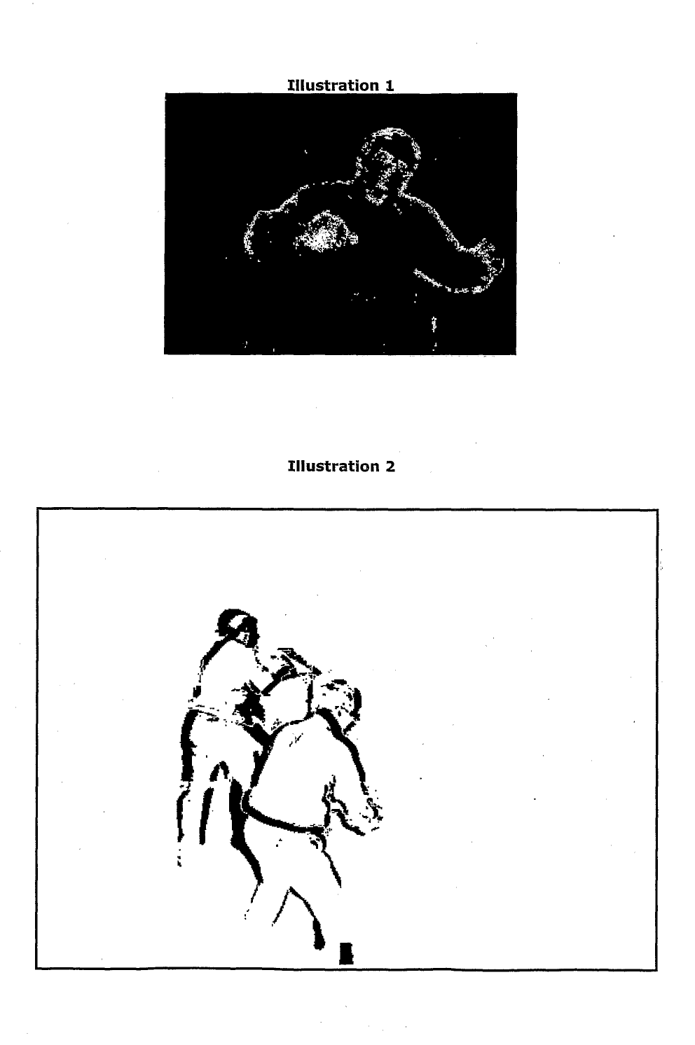

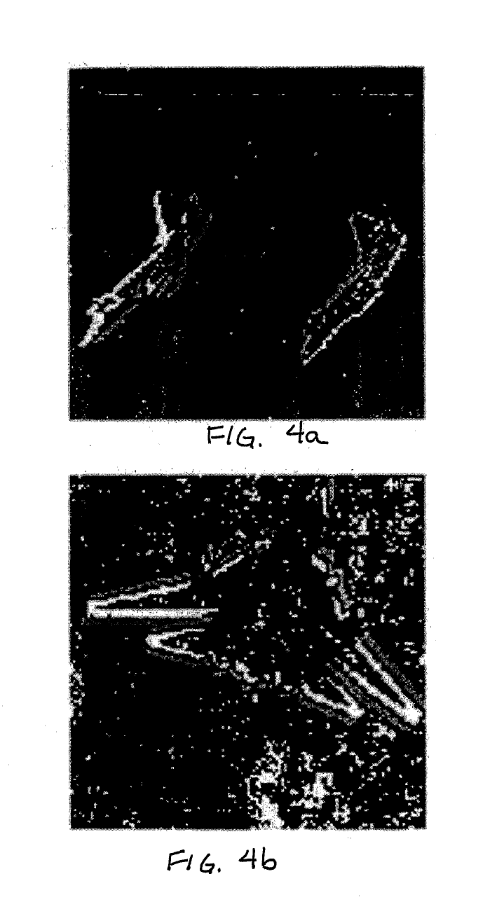

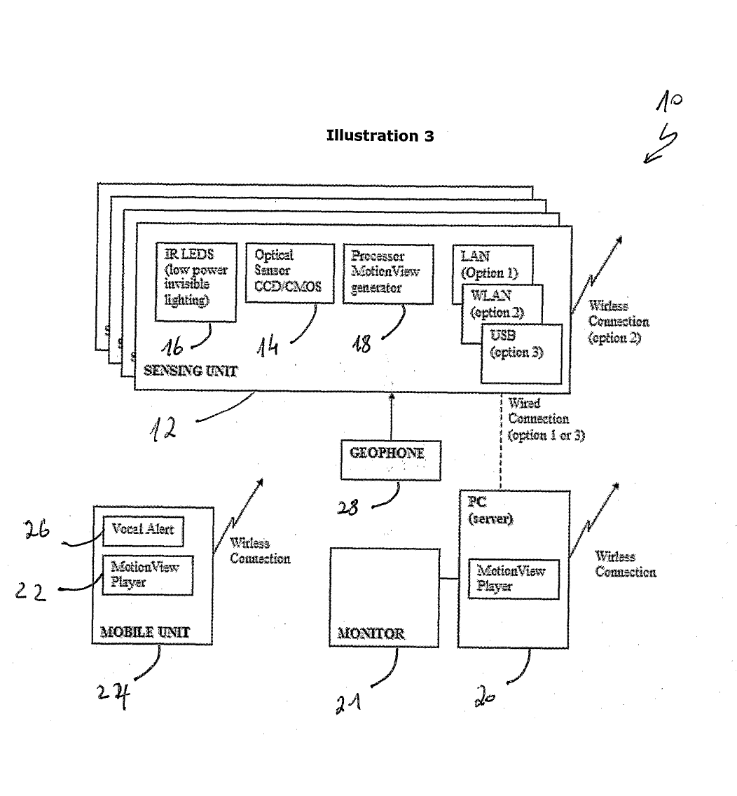

### DETAILED DESCRIPTION OF THE INVENTION

The present invention relates to a monitoring device, which provides privacy protection, for monitoring and surveillance purposes, including an optical sensor, for acquiring, analyzing and delivering a picture representing motion only. The monitoring device filters out static objects and background, indicating the character of the motion in the scene without displaying the actual pictures of the monitored individuals in the scene or of the scene itself, thus not violating their privacy. According to one embodiment of the invention, the device permits clear viewing of movement of relatively far away objects and of objects moving relatively slowly through a monitored area.

The monitoring device of the current invention avoids unnecessary privacy violation by detecting and processing a detailed image, but presenting only an image correlated to the motion of objects, as shown, for example, in Illustration 1, rather than the images of the moving objects themselves. Thus, the monitoring device of the invention displays accurately only vital information which is required for effective surveillance or monitoring of moving objects. The level of detail in the image need not be very high, just clear enough to indicate the type of action monitored, unlike the existing solutions that may reveal very detailed information when top quality equipment is used (like in department stores, clothing store dressing rooms, etc.) The current invention also permits substantial differentiation between the substantially motionless background and moving objects within such background, avoiding disclosure of background images which, in many cases, should remain concealed. Thus, when monitoring a street, only images corresponding to moving cars and people will be displayed, and images associated with all stationary objects, like buildings, trees, and parked cars, will not be displayed.

The current invention uses the full video data that can be acquired by a video sensor (daylight and/or IR) in order to detect and extract from this data and display only motion of objects within the region being covered by the optical sensor through the lens. By displaying a picture/video that illustrates the motion of monitored objects, the current invention transfers only the information necessary for providing an alert in case of intrusion or any other activity that calls for an alert or monitoring, without violating the privacy of the individuals being monitored, or disclosing details of the scene itself, since background and motionless objects are not part of the displayed picture/video at all.

An algorithm for achieving the goal of displaying an image representing the motion of objects, rather than the moving objects themselves, is preferably the one described below. However, it will be appreciated by those skilled in the present art, that it is possible to reach such a goal, with lesser accuracy and refinement or at a higher computational cost, by using other algorithms.

The preferred algorithmic concepts underlying the invention are based on the following: Given a video stream (a sequence of consecutive frames sampled over time), each pixel's luminance value (or the luminance value of a small group or block of pixels) within a given frame of the stream is transformed into an associated “motion oriented” or derived value. This transformation may be carried out using the following four steps:

1. For each pixel's value (at a given coordinate in the current frame), generate a sequence of N-pixel values associated with the same coordinate belonging to the previous N-1 frames.

2. For each generated sequence, calculate a corresponding interpolated curve.

3. For each calculated curve, approximate (numerically) the second derivative (derived acceleration value) evaluated at the current frame.

4. In the current image, replace the original pixel value with the obtained derived value.

The preferred (and perhaps the simplest) approximation of such transformation is accomplished by using luminance values from only 3 frames. If p1, p2 and p3 are corresponding pixel luminance values of the same pixel Y in each of frames 1, 2 and 3, the pixel derived value is approximated by using the formula: pY_{dv}=p1+p3−2p2; where pY_{dv} is the value assigned to pixel Y in the image to be displayed. (This is known as a “parabolic-approximation”.) The output stream of derived values results in binary bitmaps, which can be displayed, such as shown in Illustration 2, and which disclose only an image representing motion of the moving objects. These bitmaps can be displayed or monitored in any other fashion Alternatively, or in addition, the output stream can be used to generate a signal to provide an alarm or trigger another operation.

It will be appreciated that only a derived value resulting from a sharp change in the rate of change of the luminance value of a pixel will be displayed as an object. This sharp change represents the motion of an object relative to the background or another object. The derived value which is displayed can be attributed to the change from dark to light or from light to dark resulting from the motion of the object and sensed by the camera or sensor. Pixels whose luminance value does not change, or changes at a substantially constant rate over time, will be displayed as background. For many applications it is desirable to assign arbitrarily “light value” to the background and “dark value” to the moving objects so as to assign positive acceleration values to objects that are moving toward the camera direction and negative acceleration values to object that are moving further away from the camera. Various applications of these derived values are possible, where, in each application, a different threshold value can be selected. One significant manifestation of the utilization of dived values lies in its capability to detect directionality of moving objects. Positive acceleration or derived values indicate a “forward direction”, i.e. moving closer to the video camera, while negative derived values indicate a “backward direction”, i.e. moving farther away from the camera. Actually, this is, in facts, a kind of “Doppler Effect” variation.

Enhancement of the above-described display of motion correlated images is possible simply by “stacking”, i.e. summing up of a series of consecutive N frames having a given threshold derived value.

The video output generated by the preferred algorithm may consist of binary values or of a few grayscale grades, thus permitting extremely efficient open standard compression (like MJPEG, MPEG) or other form of compression methods. This is particularly important in applications where it is desired to permit monitoring or send a notification via cell phone or in similar circumstances.

Alternatively, the video output may be displayed in color. In this case, the background may be shown in one color, objects moving closer to the camera can be displayed in a second color, and objects moving farther from the camera can be displayed in a third color. Such displays are particularly useful, for example, for “sense and avoid” applications. For example, a monitoring device of the present invention, including even a relatively simple video camera, is mounted in an aircraft for monitoring the space in front of the aircraft. The display, including indications of directionality of motion, can be watched by the pilot. Additional image processing to analyze directionality of motion and/or additional sensors for added input are preferably provided to add additional functions to the monitoring system. For example, in the event that the aircraft approaches an obstacle, such as a mountain or another aircraft, the monitoring system could identify the relative motion of the object “towards” the aircraft, and provide a warning signal and/or activate a system for automatically changing the flight course of the aircraft.

Illustrations 4a and 4b illustrate this idea. In Illustrations 4a and 4b, bitmaps of two images are displayed where positive and negative accelerations are marked by white and gray colors, respectively, on a black background. The aircraft in Illustration 4a is outlined by a stripe of gray color indicating that it is moving further away from the observing camera. The white line in this image indicates the former positions over time of the aircraft relative to the background. In Illustration 4b, gray stripes appear at the top of the lower aircraft and at the bottom of the upper aircraft, indicating that they are moving away from each other (and there is no risk of collision). Preferably, the background is displayed as relatively light and the “moving” objects as relatively dark.

Referring now to Illustration 3, there is shown a block diagram of the structure of a monitoring system 10 constructed and operative according to one embodiment of the invention. The monitoring system 10 includes a sensing unit 12, housing video frame acquiring components and processing components, coupled to display and/or alerting components. The video frame acquiring components may include a lens and a CCD/CMOS optical sensor (daylight/IR) 14. If desired, IR LEDs 16 for low power invisible lighting, or other light source, may also be provided in sensing unit 12. The processing components 18 include the preferred algorithm and the processing platform, which could be an embedded CPU/DSP/Media Processor/ASIC or a PC platform, for example. The alerting components could include streaming components and a remote server 20 or client with any kind of appropriate monitor 21, or a mobile unit 24 having a motion view player 22 coupled to a display (not shown), and an internal warning system 26 or an external display and/or warning system. Such a system can be implemented in various ways. One preferable embedded design suited for demented elderly patients is illustrated in Illustration 3.

Since this system is meant to provide an alert concerning a fall of a patient, and a visual alert may not allow sufficient time for the paramedic or attendant to arrive in time, the system is preferably coupled with a geophone 28 for sensing and providing an output of vibrations in the floor, which independently, or combined with the optical observation, can provide an alert after a fall of a patient in a given room or hallway.

A similar system could be utilized for monitoring babies to prevent crib death. For example, a thermal camera can be utilized to observe breathing and air movement around the baby. The thermal camera would capture images of the breath of the baby, which would be displayed for viewing by parents or caretakers. In addition, further processing of the data could be utilized to provide an output signal when lack of movement over a pre-selected period of time is detected so that an audible alert could be provided.

According to a preferred embodiment of the present invention, relatively slow motions of objects can be detected by continuously comparing derived values of the same video sequence applied simultaneously to pairs of frames sampled at different rates. For example, such a system can be utilized as a sort of optical radar, to track relatively slow or distant moving objects. In this case, frames from the video stream may be selected one per minute or one per hour, rather than consecutive frames, and the above analysis performed on the image data. The resulting bit map display will represent the motion of objects in the monitored area over a longer time frame, but will display that motion-representing image as if it were accelerated. This permits observation of slowly moving objects close to the camera and of faster moving but far-away objects which, due to perspective, appear to the eye to be moving slowly, as all stationary background will be filtered out and not appear in the display. This embodiment is particularly suitable for detecting the stealthy approach of enemy soldiers or aircraft.

On the other hand, relatively rapid motion of objects can be processed so as to display each frame value several times, thereby providing a display in “slow-motion”. This embodiment could be used, for example, for analyzing motion of cells and/or medicines which are observed through a microscope, in order to compare and/or calculate delivery rates of the medications to their destination.

According to yet another embodiment of the invention, sampling and mapping of the derivatives of the luminance values of the same area can be carried out at different time intervals, followed by simultaneous display, for example, in different colors. In this way, slow movements would be displayed in one color, while rapid movements would be displayed in a different color, but both types of movement could be observed simultaneously.

It will be appreciated that the monitoring device can be integrated into a complete monitoring system, including elements for encoding, recording, displaying, storing and/or transmission of data, as well permitting further processing to provide an output signal for remotely activating alarms, etc. Due to the binary nature of the processed data, and the relatively small quantity of data required for the derived image, it can be compressed extremely efficiently. This is advantageous as data covering long periods of time can be stored efficiently, and the data can be conveniently sent via SMS and other similar systems. This permits the monitoring and surveillance of stores, public places, offices etc. without violating the privacy of the individuals in the scene and of the scene itself, while providing an efficient method for rapid transfer of data to be displayed and/or of alert messages.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A method for monitoring comprising:
capturing video frames over time;
processing data from said captured video frames into derived data representing a rate of change of said captured data;
creating new frames from said derived data; and
storing said new frames.

2. The method according to claim 1, wherein said data is luminance data.

3. The method according to claim 1, further comprising displaying said new frames.

4. The method according to claim 3, wherein said derived data representing a rate of change of said captured data above a threshold value is displayed in contrast to a portion of said derived data representing a rate of change below said threshold value.

5. The method according to claim 4, further comprising:
determining from said derived data a direction of said rate of change; and
displaying one direction in contrast to an opposite direction.

6. A method for monitoring comprising:
acquiring a sequence of video frames, each pixel in each said frame having a luminance value;
calculating from at least three video frames in said sequence at least a second derivative of said luminance values for each pixel over time;
assigning the calculated derived value to each said pixel; and
creating a bitmap from said calculated derived values, corresponding to movement of objects in said frames.

7. The method according to claim 6, wherein said step of calculating comprises:
for each pixel's value at a given coordinate in the current frame, generate a sequence of N-pixel values associated with the same coordinate belonging to the previous N-1 frames;
for each generated sequence, calculate a corresponding interpolated curve;
for each calculated curve, estimate numerically a second derivative evaluated at the current frame;
in the current frame, replace each original pixel value with the obtained derived value.

8. A monitoring device comprising:
an optical sensor for acquiring a sequence of video frames over time;
a processor for processing data from said acquired video frames into derived data representing a rate of change of said acquired data and for creating new frames from said derived data.

9. The device according to claim 8, wherein said processor is adapted and configured for calculating at least a second derivative of luminance of each pixel in said frames as sampled over time and assigning said derivative value to each pixel, so as to create new frames representing movement of objects in said frames.

10. The monitoring device according to either claim 8 or claim 9, further comprising a display for displaying said new frames.

11. The device according to any of claims 8 to 10, wherein:
said processor further comprises software means for determining from said derived data when pre-defined conditions are met and providing an output signal, and
said device further comprises an alerting mechanism for providing an alert in response to said output signal.

12. The device according to any of claims 8 to 11, further comprising a second sensor.
